(19) United States
(12) Patent Application Publication
(10) Pub. No.: US 2022/0348147 A1
(43) Pub. Date: Nov. 3, 2022

(54) Low-Profile Panel Assembly for Providing Sound Within a Passenger Compartment of a Vehicle

(71) Applicant: JVIS-USA, LLC, Shelby Township, MI (US)

(72) Inventors: Darius J. Preisler, Macomb, MI (US); Jason T. Murar, Macomb, MI (US); Robert C. Koehn, Roseville, MI (US); Alexis Antonio Silva Perez, Macomb, MI (US)

(73) Assignee: JVIS-USA, LLC, Shelby Township, MI (US)

(21) Appl. No.: 17/245,740

(22) Filed: Apr. 30, 2021

(51) Int. Cl. B60R 11/02; B60R 13/02

(52) U.S. Cl. CPC B60R 11/0217; B60R 13/025; B60R 13/0212; B60R 2011/0022

(57) ABSTRACT

A low-profile panel assembly configured to provide sound having at least one acoustic wavelength within a passenger compartment of a vehicle is provided. The vehicle has a support structure. The assembly includes a substrate panel perforated with at least one sub-wavelength hole which extends between front and back surfaces of the panel. The panel is configured to be attached to the support structure. A continuous membrane of facing material overlies and is in contact with the panel. The membrane is tightly stretched over and covers the at least one hole at the front surface of the panel. An electroacoustic sound source is configured to radiate acoustic waves against the back surface of the panel. The radiated acoustic waves travel through the at least one membrane-covered hole to vibrate at least one portion of the membrane which tightly covers the at least one hole. The at least one vibrating portion of the membrane radiates acoustic waves into the passenger compartment of the vehicle.

### TECHNICAL FIELD

This invention generally relates to vehicular audio systems and, in particular, to such systems which have at least one low-profile panel assembly for providing sound within a passenger compartment of a vehicle.

### OVERVIEW

Sound waves are longitudinal mechanical waves. They can be propagated in solids, liquids, and gases. The material particles transmitting such a wave oscillate in the direction of propagation of the wave itself. There is a large range of frequencies within which longitudinal mechanical waves can be generated, sound waves being confined to the frequency range which can stimulate the human ear and brain to the sensation of hearing. This range is from about 20 cycles/sec to about 20,000 cycles/sec and is called the audible range.

Audible waves originate in vibrating strings (violin, human vocal cords), vibrating air columns (organ, clarinet), and vibrating plates and membranes (xylophone, loudspeaker, drum). All of these vibrating elements alternately compress the surrounding air on a forward movement and rarefy it on a backward movement. The air transmits these disturbances outward from the source as a wave. Upon entering the ear, these waves produce the sensation of sound. Waveforms which are approximately periodic or consist of a small number of approximately periodic components give rise to a pleasant sensation (if the intensity is not too high), as, for example, musical sounds. Sound whose waveform is nonperiodic is heard as noise.

Vibrating rods, plates, and stretched membranes give rise to sound waves. Consider a stretched flexible membrane, such as a drumhead. If it is struck a blow, a two-dimensional pulse travels outward from the struck point and is reflected again and again at the boundary of the membrane. If some point of the membrane is forced to vibrate periodically, continuous trains of waves travel out along the membrane. Just as in the one-dimensional ease of a string, so here too standing waves can be set up in the two-dimensional membrane. Each of these standing waves has a certain frequency natural to (or characteristic of) the membrane. Again, the lowest frequency is called the fundamental and the others are overtones. Generally, a number of overtones are present along with the fundamental when the membrane is vibrating. These vibrations may excite sound waves of the same frequency.

The nodes of a vibrating membrane are lines rather than points (as in a vibrating string) or planes (as in a pipe). Since the boundary of the membrane is fixed, it must be a nodal line. In general, all elastic bodies will vibrate freely with a definite set of frequencies for a given set of boundary or end conditions. These frequencies are called proper frequencies, characteristic frequencies, or eigenfrequencies of the system.

Traditionally, individual moving coil and cone loudspeakers are placed within the doors, instrument panel, and rear tray and elsewhere in a vehicle for providing sound within the vehicle. These speakers add substantial weight to a vehicle, require individual installation and connection, occupy valuable interior trim space, allow significant road noise intrusion, and are subject to substantial shock and environmental abuse.

Most significantly, they are poorly positioned for listening. Their on-axis radiation is typically directed low in the vehicle towards occupant's legs and midsections rather than at the occupant's ears. The direct sound from the speaker to the listener is typically far off-axis and highly variable in frequency response with typically insufficient high frequencies. In the high noise environment of a vehicle, this typically results in mid and high frequency audio information getting lost. “Imaging”, the perception of where sound is coming from, is also adversely affected since the loud-speakers are low in the vehicle; for the front passengers, the audio image is pulled down into the doors while the rear passengers have an image to the side or rear instead of what should be presented in front of them.

As a solution to this problem, some proposed systems, including the system described in the U.S. patent to Clark et al., U.S. Pat. No. 5,754,664, have incorporated small, light-weight loudspeaker drivers above the occupants in the headliner in addition to the door and rear package tray speakers. Unfortunately, the small loudspeaker can still be localized due to the fact that the listener is far enough to be in the free field of acoustic radiation but not far enough to be experiencing a plane wave condition.

This phenomenon, as documented by Soren Bech and others results in an unnatural simulation of an acoustic space. S. Bech, “Electroacoustic Simulation of Listening Room Acoustics. Psychoacoustic Design Criteria,” Audio Engineering Society, 89^{th} Convention 21-25 Sep. 1990, Los Angeles, USA, 34 pages. The most significant drawback of this approach, however, is that the overall system complexity and cost is increased due to the addition of individual drivers overhead while the conventional speakers still remain in the doors and rear package tray. Furthermore, the noise paths through the door and rear package trays still exist and more noise paths from the roof (as occurs in rain) are opened with the new lightweight cone speakers in the headliner. Lastly, making the drivers invisible would be extremely difficult, since the small speakers are mounted onto the headliner; even if acoustically transparent fabric were placed over the drivers, the holes in the headliner would result in “read-thru” or visibility.

The Verity Group PLC and its successors have applied for a number of patents covering various aspects of flat panel loudspeaker (i.e., NXT) technology. The technology operates on the principle of optimally distributive modes of vibration. A panel constructed in accordance with this technology has a very stiff structure and, when energized, develops complex vibration modes over its entire surface. The panel is said to be dispersive in that the shape of the sound wave traveling in the panel is not preserved during propagation.

Unfortunately, distributed mode panel loudspeakers require precise geometries for exciter placement and panel suspension thus limiting their size and integration capabilities into a headliner. Essentially, they would be separate speakers assembled into a hole in the headliner or onto the surface of the headliner. In the first case, they would also result in extra noise transmission (since the panels are extremely light) or in the second case, they would be visible to the occupants either as bumps or edges in typical headliner covering materials. In both cases, added complexity is the result.

From a sonic performance viewpoint, distributed mode panels suffer from poor low frequency response (typically restricted to 250 Hz and above for sizes integral to a headliner) and low output. Neither of these conditions make NXT panels suitable for headliner applications, particularly in a high noise environment. Furthermore, distributed mode panels are incapable of precise imaging, presenting instead a diffuse acoustic field perception where the sound appears to come form everywhere. While distributed mode panels might improve overall spaciousness, they would still require full range loudspeakers in the doors or rear package tray for sufficient acoustic output and other speakers in front for proper imaging.

In the U.S. patent to Parrella et al. U.S. Pat. No. 5,901,231, driving portions of interior trim with piezo-electric elements to reproduce audio frequencies is disclosed. However, the use of piezo-electric elements restricts them to dividing up the trim into different sections for different frequency ranges adding complexity to the system. Furthermore, the excursion limits of piezo elements limits the output level and low frequency range of the trim panels such that conventional cone speakers would be required to produce lower frequencies. The piezo elements also require complicated integration into the trim element and are difficult to service. Lastly, the piezo elements require additional circuitry to convert typical output from an automotive head unit further complicating the system.

The above-noted application entitled “Integrated Panel Loudspeaker System Adapted To Be Mounted In A Vehicle” describes flat panel systems with an electromagnetic drive mechanism integrated into an aperture in the panel. However, the driving mechanism that is integrated into the panel is constructed without steel pieces to contain, direct and concentrate the magnetic flux to its best advantage. The voice coil required is also relatively massive severely limiting the high frequency output. Thus, the output level is not adequate for typical audio performance. Furthermore, the aperture that the electromagnetic drive mechanism is insufficiently stiff to produce high frequency output.

The U.S. patents to Marquiss U.S. Pat. Nos. 4,385,210, 4,792,978 and 4,856,071 disclose a variety of planar loudspeaker systems including substantially rigid planar diaphragms driven by cooperating coil and magnet units.

The prior art discloses attempts to incorporate the exciter of a flat panel speaker design onto a trim panel using the trim element itself as the vibrating diaphragm. However, significant difficulties have been encountered in this approach. For example, U.S. Pat. No. 7,050,593 illustrates use of an automotive panel as the sound surface for a flat panel speaker. U.S. Pat. No. 6,377,695 similarly discloses an exciter attached to vehicle roof lining, door panels, dashboards, and rear parcel shelves, and it discloses foam materials for the radiating sound surface. Other materials typically used for the disclosed trim surfaces include glass-filled urethane foam and molded plastics such as PVC and PPO. Thus, the typical materials used for automotive trim surfaces tend to be sound absorbent and are far from ideal for use to propagate sound.

A further problem relates to damping and isolation. By mounting an exciter directly to the backside of a headliner or other trim panel substrate, the sound production area (i.e., the region where panel vibrations generate sound) may extend to other assembled components on the panel (e.g., lighting components, panel attachment points, and electrical accessories) which may adversely affect the resonance of the acoustic surface and its ability to reproduce sound.

Yet another problem associated with known arrangements relates to inefficiency of the resulting speaker. The exciter must overcome its own mass when energized due to the fact that it is solely supported by its attachment with the panel surface. This limits voice coil excursion and the subsequent transmission of sound into the acoustic sound surface.

Despite the above problems, flat-panel loudspeakers are becoming increasingly important for today's consumer market. The invisible integration, wide and diffused radiation and improved room interaction are features of flat-panel loudspeakers, for improving the perceived audio quality. Furthermore, large and more powerful devices can be integrated without disturbing customers' views or disrupting the aesthetics of a room. However, in addition to invisible integration, flat-panel loudspeakers must possess acoustic quality that is comparable to that of conventional systems. Customers of audio devices expect that the audio signal can be reproduced at a sufficient amplitude and quality. The acoustic quality can be expressed in terms of frequency limits, the maximum sound pressure level, the flatness of the pressure response, the harmonic and nonlinear distortions and the radiation characteristics.

U.K. published patent application 2,492,100 discloses a method of fabricating an illuminated trim panel member in which the panel member comprises a trim element. The method comprises: forming, such as by laser drilling, at least one aperture completely through the trim element; and applying a layer of a light-transmitting coating medium to one side of the trim element to cover at least a portion of the one side and the aperture, whereby light may be transmitted completely through the aperture and through the layer of coating medium for viewing.

As described in Chapter 13 of the Handbook of Laser Materials Processing entitled “Hole Drilling,” there are two ways of forming apertures or holes using laser beams: percussion drilling and trepanning. Percussion drilling is typically used for hole diameters less than 0.025 in. (0.63 mm), while trepanning is used for drilling holes of larger diameter.

Trepanning

If one uses a rotating optical device, holes up to ≈0.250 in. (6.25 mm) diameter can be laser drilled. So-called “boring heads” rotate the focused laser beam at very high rates. Holes are drilled by either a single pass or multiple passes of the laser beam.

Drilling by trepanning is to cut a hole around its periphery. Depending on the hole diameter, a slug may be produced. Boring heads usually use 2.5-in. focal length lenses and are equipped with gas jets similar to those used for laser cutting applications.

Roundness of the holes produced by boring heads is exact, and repeatability of hole diameter is excellent. Boring-head-hole diameter is established either manually or by use of a programmable controller.

Trepanned holes can also be drilled by interpolation of linear axes, moving either the material or the laser focusing device. Speed of drilling by interpolation is dictated by the size of the linear axes. The linear axes servo system must be properly tuned to produce circular holes. Specialty beam-manipulation devices use very small linear axes to move the focusing device in a circle. The system controller can be programmed to establish desired hole diameters.

Most nonmetals are of one of two types, characterized by their response to exposure to high-energy radiation: those that transform from a solid directly into a vapor without significant liquefaction, and those that transform from solid state into a liquid state before vaporization. Paper is an example of the former; acrylic resin is an example of the latter.

When absorbed by a material, this energy is transformed into energy associated with the motion of atoms or molecules and is capable of being transmitted through solids or fluids by conduction, that is, as heat. Most nonmetals do not conduct heat effectively. Properly applied, the effect of short, high-energy laser pulses is localized to the area of exposure. As such, each pulse of laser energy affects a volume of material consistent with the irradiance of the focuses beam and the specific heat of the material, with negligible impact to material adjacent to the area of exposure.

The total energy required to drill a hole comes from the specific gravity of a material and the volume of material which must be converted from solid to vapor. The rate at which holes can be drilled is determined by the rate at which energy can be input to the material without degrading hole quality.

Hole quality is quantified by the measures of roundness and taper; recast (material that has resolidified in the hole or around the hole entrance); or charring (usually exhibited as a carbonaceous residue). These qualities affect the function of the hole, whether it be air flow, spray pattern, or part fit.

Many molded parts are used in the interior of vehicles. The substrate of the part is often made of plastic or of a fibrous molding material.

Natural fiber composite panels utilized as a substrate have very important characteristics because of their light weight and high environmental sustainability.

The substrate of the molded part may be realized in a laminar fashion and has an essentially plane contour or a three-dimensional contour with convex and concave regions defined by the respective design, as well as, if applicable, one or more openings and recesses. In order to fix the molded parts in the passenger compartment or on the vehicle door and to mount handles, control elements and storage trays on the molded part, the molded part is also equipped with mounting parts that are also referred to as retainers.

The substrate typically consists of plastics or composite materials that contain plastics such as acrylonitrile-butadiene-styrene (ABS) or polypropylene (PP). Fibrous molding materials on the basis of textile fabrics of hemp, sisal, flax, kenaf, and/or wood components such as wood fibers, wood dust, wood chips or paper bound with duroplastic binders are likewise used as material for the substrate. Foamed materials of polyurethane or epoxy resins that, if applicable, are reinforced with natural fibers or glass fibers may also be considered as material for the substrate.

The side of the respective molded part or substrate that faces the vehicle interior is usually referred to as the visible side. In order to provide the visible side with an attractive appearance, the substrate is equipped with one or more decorative elements of a textile material or a plastic film. The plastic films are used for this purpose are usually colored and have a relief-like embossed surface. If applicable, the decorative elements comprise a cushioning layer of a foamed plastic that faces the substrate and provides the molded part with pleasantly soft haptics. The decorative elements are usually laminated onto the substrate or bonded thereto during the manufacture of the substrate by means of thermoplastic back-injection molding.

On its edge and/or on an installation side that lies opposite of the visible side, the substrate is advantageously equipped with projections, depressions and bores. The projections, depressions and bores serve for non-positively connecting the molded part to sections of the car body such as a car door or the roof of a passenger compartment by means of retaining elements such as clips, pins and screws.

The term “facing material” refers to a material used to conceal and/or protect structural and/or functional elements from an observer. Common examples of facing materials include upholstery, carpeting, and wall coverings (including stationary and/or movable wall coverings and cubicle wall coverings). Facing materials typically provide a degree of aesthetic appearance and/or feel, but they may also provide a degree of physical protection to the elements that they conceal. In some applications, it is desirable that the facing material provide properties such as, for example, aesthetic appeal (for example, visual appearance and/or feel) and abrasion resistance. Facing materials are widely used in motor vehicle construction and may include leather.

Leather is a general term for tanned hides whose original fiber structure is retained substantially intact. Excluding splits or parts of the skin that were removed prior to tanning and are not used as automobile leather on principle, the leather comprises a grain layer, or top skin, and a dermis. The top skin makes up only a fraction of the total thickness of the leather.

Difficulties have arisen in attempting to use leather on molded parts or substrates. First, natural leather is a nonuniform material whose thickness, tear strength and surface finish vary over a wide range. Attempts have been made to glue or otherwise adhere pieces of leather over molded or other preformed vehicle interior parts. Difficulties have also arisen in obtaining proper adhesion of the leather to the preformed part. The leather will loosen and/or peel away form the underlying part over time.

Other attempts have incorporated leather sheets or otherwise made from multiple leather pieces. However, such products have required raised, sewn seams and have not provided the desired smooth finished leather look desired by vehicle manufacturers. Moreover, the labor intensive costs associated with producing such covers have been high.

A concurrent problem in the use of leather covered, molded articles generally have been the inability to obtain a proper leather grain appearance on the exposed surface of the article. Manufacturing procedures in applying leather covers to preformed articles with adhesives and the like have often diminished the naturally appearing grain in the leather and provided an almost smooth appearance instead of the desired natural leather grain. In addition, it has been difficult with past procedures to properly adhere the leather to a preformed article such that the leather remains secured to the article for proper appearance over its life.

In the automotive industry, it is common practice to refer to various surfaces as being A-, B-, or C-surfaces. As used herein, the term “A-surface” refers to an outwardly facing surface for display in the interior of a motor vehicle. This surface is a very high visibility surface of the vehicle that is most important to the observer or that is most obvious to the direct line of vision. With respect to motor vehicle interiors, examples include dashboards, door panels, instrument panels, steering wheels, head rests, upper seat portions, headliners, load floors and pillar coverings.

According to classic acoustic theory, there are a number of requirements which, when met, result in good acoustics as follows:

Appropriate reverberation time (i.e. must be substantially the same throughout the entire frequency range);

Uniform sound distribution (i.e., where the sound must be able to be heard equally well everywhere in a room or vehicle cabin);

Appropriate sound level (i.e., normal conversation is 60-65 dB, and in a busy street 70-85 dB).

Appropriate, low background noise (i.e., is one of the most important acoustic criteria). In a vehicle cabin, the background noise may come from ventilation systems.

No echo or flutter echoes (i.e., must occur for the acoustics to be good).

As described in paper entitled “Improved Sound Radiation of Flat Panel Loudspeakers Using the Local Air Spring Effect,” Zemker, B. et al., Appl. Sci., 2020, 10, 8926, flatness of the response is essential to the listener. Flat panel loudspeakers have higher deviations than conventional systems. In particular, in the low-frequency range, the modal density is low on the logarithmic frequency sale. To optimize the spectrum of flat panel loudspeakers, the distance between the modal frequencies is optimized to give the illusion of a continuous spectrum. However, in many cases, it is not possible to increase the modal density in the low frequency range: the material properties, the thickness of the panel and the design are fixed. Therefore, the lack of a low-frequency response needs to be resolved by construction or excitation. Deviations of more than 20 dB in the lower frequency range are possible. The deviations decrease for higher frequencies.

Several constructive and control approaches have already been developed to improve the flatness of flat-panel loudspeaker responses. It is known that the damping of the boundary conditions, as well as the stiffness and damping of the coupled air volume (panel volume) or individual attached concentrated masses, have a positive influence on the pressure response. Another sufficient control variable is the position of the exciter. This can be optimized with a numerical analysis to find the best excitation positions in a fast and automated way. The achievable effect is physical limited. A single force driver is not able to excite all eigenmodes in an efficient way. Consequently, individual modes are excited with different levels of intensity, which occurs due to the superposition as a flatter pressure response.

An alternative solution is the usage of an array of force drivers to selectively excite the lowest eigenmodes of the flexible panel. This construction enables the same acoustic performance as a conventional speaker within the array-addressable frequency region. However, it increases the costs and complexity due to the higher number of exciters and controlled outputs of the DSP.

The last approach is known as the paneled woofer design. A conventional woofer radiates into a small air gap between the panel and a separation plate and excites the panel uniformly. This results in a flat response, which is comparable to a conventional woofer design. This design is limited to higher frequencies and needs to be supplemented by an exciter.

The above-noted article by Zemker et al. introduced a new control variable-modal related air compliance. It is known via U.S. Pat. No. 6,553,124 that the spring of the panel volume has a strong modal-dependent influence and can shift modes individually based on their effective radiating area. The different local air compliance of an irregular shaped enclosure was used to change the mode shape of the individual structural modes and suppress the panel's anti-phase components. Compared to a simple cuboid enclosure, the irregular shaped enclosure created local pressure changes that cause a local panel stiffening. This minimized dips and improved the frequency response without adding mass to the system. In other words, the above article by Zemker et al. introduced an approach to improve the frequency response of an exciter-driven flat-panel loudspeaker. The introduced modal-related air compliance was used to suppress modes with a high amount of anti-phase components. This was realized with a separation plate, which was mounted at a certain distance directly behind the panel to create an irregular shaped enclosure. The panel was stiffened due to the additional air spring caused by the paneled volume leading to a flatter transfer function.

The following U.S. patent documents are related to at least one embodiment of the present invention: U.S. Pat. Nos. 10,252,802; 9,834,320; 9,154,862; 8,942,392; 7,817,810; 2003/0035560; U.S. Pat. Nos. 6,553,124; 6,639,988; 9,967,692; 9,888,319; 2017/0150288; 2017/0034622; 2016/0080881; 2015/0358725; 2014/0355793; U.S. Pat. Nos. 8,090,116; 8,073,156; 7,088,836; 9,326,053; 10,841,704; 7,194,098; 6,760,461; 6,676,879; 6,522,755; 6,356,641; 6,324,294; 6,320,967; 6,215,884; 6,181,797; 9,725,047; 7,916,878; 7,684,577; 8,208,655; 8,155,344; 2004/0047476; 6,721,436; 6,694,036; 2002/0081980; U.S. Pat. Nos. 4,720,867; 4,551,849; 4,514,599; 4,550,422; and 4,499,340.

Thus, even with the above prior art advancements in speaker technology, prior vehicular audio systems have not been significantly simplified. There is still a need to reduce part count, labor cost, decrease weight, decrease exterior noise penetration, provide believable imaging, reduce speaker visibility, increase reliability, and provide easy serviceability.

It is therefore desirable to provide a vehicular audio system which achieves the above by using existing trim panel space and mounting techniques, advanced material property manipulation and well-established psychoacoustic techniques.

### SUMMARY OF EXAMPLE EMBODIMENTS

An object of at least one embodiment of the present invention is to provide a low-profile panel assembly for providing sound within a passenger compartment of a vehicle wherein the assembly may be located at pillars, doors, package trays, trunks, seats, and dashboards of a vehicle thereby reducing weight, cost, and complexity of vehicular audio systems while freeing up valuable space formerly allocated for conventional speakers.

In carrying out the above object and other objects of at least one embodiment of the present invention, a low-profile panel assembly configured to provide sound having at least one acoustic wavelength within a passenger compartment of a vehicle is provided. The vehicle has a support structure. The assembly includes a substrate panel perforated with at least one sub-wavelength hole which extends between front and back surfaces of the panel. The panel is configured to be attached to the support structure. A continuous membrane of facing material overlies and is in contact with the panel. The membrane is tightly stretched over and covers the at least one hole at the front surface of the panel. An electroacoustic sound source is configured to radiate acoustic waves against the back surface of the panel. The radiated acoustic waves travel through the at least one membrane-covered hole to vibrate at least one portion of the membrane which tightly covers the at least one hole. The at least one vibrating portion of the membrane radiates acoustic waves into the passenger compartment of the vehicle.

The substrate panel may be a plastic molded panel.

The plastic molded panel may be injection molded.

The substrate panel may comprise an automotive vehicle trim panel.

The substrate panel may be concavely formed and the back surface of the substrate panel may define a recess in which the sound source is disposed.

The sound source may comprise a loudspeaker.

The substrate panel may be configured to be attached to a pillar of the support structure.

The at least one hole may be a microperforation which is laser-drilled in the substrate panel.

The substrate panel may be microperforated with a plurality of sub-wavelength holes.

The facing material may be leather.

In further in carrying out the above object and other objects of at least one embodiment of the present invention, a low-profile panel assembly configured to provide sound having at least one acoustic wavelength within a passenger compartment of a vehicle is provided. The vehicle has a support structure. The assembly includes a substrate panel perforated with an array of subwave length holes which extend between front and back surfaces of the panel. The panel is configured to be attached to the support structure. A continuous membrane of facing material overlies and is in contact with the panel. The membrane is tightly stretched over and covers the array of holes at the front surface of the panel. A plurality of electroacoustic sound sources are configured to radiate acoustic waves against the back surface of the panel. The radiated acoustic waves travel through the array of membrane-covered holes to vibrate portions of the membrane which tightly cover the array of holes. The vibrating portions of the membrane radiate acoustic waves into the passenger compartment of the vehicle.

The substrate panel may be a plastic molded panel.

The plastic molded panel may be injection molded.

The substrate panel may comprise an automotive vehicle trim panel.

The substrate panel may be concavely formed and the back surface of the substrate panel may define a recess in which the sound sources are disposed.

The sound sources may comprise loudspeakers.

The substrate panel may be configured to be attached to a pillar of the support structure.

The array of holes may be microperforations which are laser-drilled in the substrate panel.

The substrate panel may be microperforated with the array of sub-wavelength holes.

The facing material may include leather.

### BRIEF DESCRIPTION OF THE DRAWINGS

FIG. 1A is an interior, perspective, environmental view, partially broken away, of an automotive vehicle in which at least one embodiment of the present invention is radiating three sets of acoustic waves into a passenger compartment of the vehicle;

FIG. 1B is an enlarged view of a portion of the view of FIG. 1A contained within the dashed box of FIG. 1A to illustrate the relative size of a hole (illustrated in phantom) in a substrate panel of the assembly;

FIG. 2 is a view, partially broken away and in cross section, taken along lines 2-2 of FIG. 1A to illustrate loudspeakers, holes extending through the substrate panel and a continuous membrane covering the holes; and

FIG. 3 is a view, partially broken away and in cross-section, and partially in schematic, which illustrates an injection molding machine, a hole-drilling laser and an embodiment of an assembly constructed in accordance with the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As used herein, the term “microperforations” may include circular and/or non-circular shaped micro-holes. The term “non-circular” may include any arbitrary shape that is not circular. The term “diameter” may be taken to mean the minimum distance across an opening of the microperforation at a point through the centroid of the microperforation, where the centroid and diameter are based on the area of the microperforation on a surface of the panel in which the microperforation is present. For example, when the microperforations are substantially circularly cylindrical, the diameter is the distance across the center of the circle defining the opening.

The openings of the microperforations may be non-circular such that the microperforation is not circularly cylindrical. In these cases, the “diameter” may be taken to mean the minimum distance across the non-circular opening of the microperforation that crosses through the centroid. The terms “hole” and “microperforation” are used interchangeably.

In some embodiments, the microperforations have a generally circular cross-section through the thickness of the panel. In some embodiments, the microperforations have a non-circular cross-section through the thickness of the panel. In some embodiments, the shape of the microperforation through a cross-section of a panel varies, or is substantially constant.

In some embodiments, the diameter is between 0.02 mm and 5 mm, between about 0.05 mm and 2 mm, between about 0.1 mm and 2 mm, between about 0.1 mm and about 1 mm, between about 0.1 mm and 0.6 mm.

As used in this application, the term “substrate” refers to any flexible, semi-flexible or rigid single or multi-layer component having a surface to which a decorative membrane is or can be applied. The substrate may be made of polymers and other plastics, as well as composite materials. Furthermore, the shape of the substrate and particularly the surface to be covered can be any part of an assembly or device manufactured by any of various methods, such as, without limitation, conventional molding, extruding, or otherwise fabricated.

The term “overlies” and cognate terms such as “overlying” and the like, when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent layers.

Referring now to the drawing figures, a low-profile panel assembly, generally indicated at 10, is configured to provide sound (in the form of sets of acoustic waves 12) having at least one acoustic wavelength within a passenger compartment 14 of a vehicle, generally indicated at 16, having a support structure (not shown). The assembly 10 includes a substrate panel, generally indicated at 18, perforated with an array of sub-wavelength holes 20 which extends between front and back surfaces, 22 and 24, respectively, of the panel 18. The panel 18 is configured to be attached to the support structure.

The assembly 10 also includes a continuous membrane, generally indicated at 26, of facing material overlying and in contact with the panel 18. The membrane 26 is tightly stretched over the array of holes 20 at the front surface 22 of the panel 18.

A plurality of electroacoustic sound sources 28 are configured to radiate sets of acoustic waves 30 against the back surface 24 of the panel 18. The waves 30 travel through the array of membrane-covered holes 20 to vibrate portions 32 of the membrane 26 which tightly cover the array of holes 20. The vibrating portions 32 of the membrane 26 radiate the sets of acoustic waves 12 into the passenger compartment 14 of the vehicle 16.

The panel 18 may be made of a thermoplastic material. For example, the panel 18 may be made of a material such as a polycarbonate resin containing acrylonitrile, butadiene, and styrene (PC-ABS) material, thermoplastic elastomer etherether (TEEE), polypropylene, the product having the trade name Santoprene™ supplied by Monsanto Company, or a thermoplastic polyolefinic (TPO) material.

The substrate panel 18 may be a plastic molded panel.

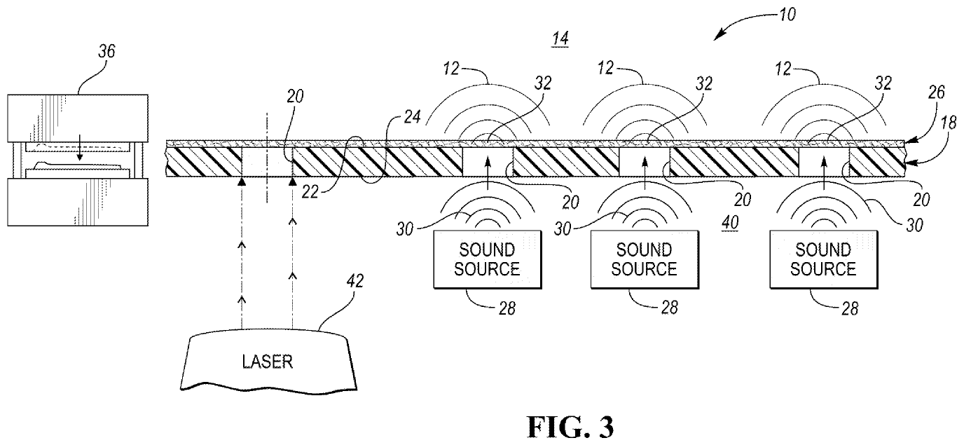

The plastic molded panel 18 may be injection molded as illustrated by the injection molding apparatus 36 in FIG. 3.

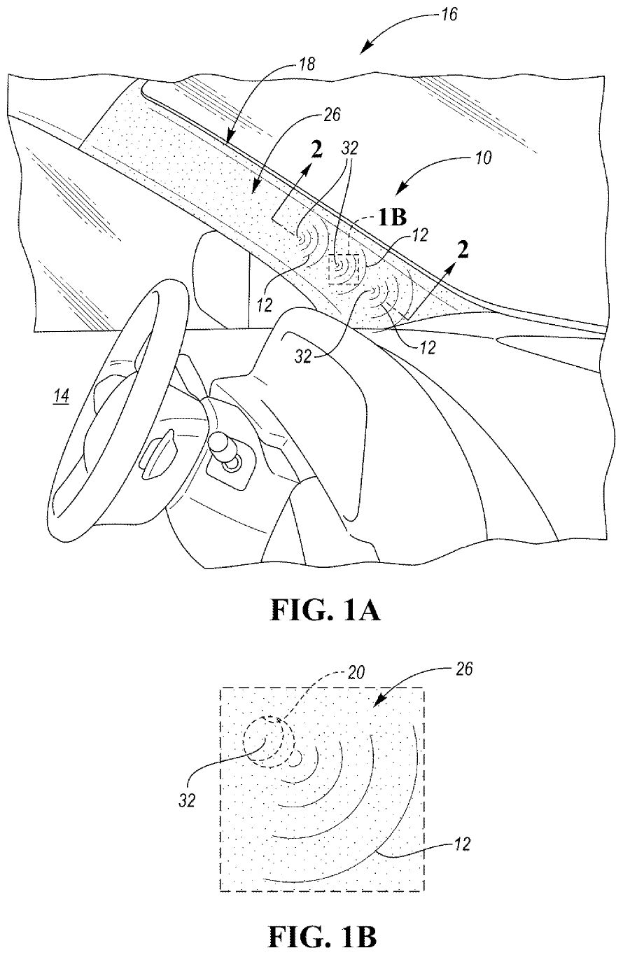

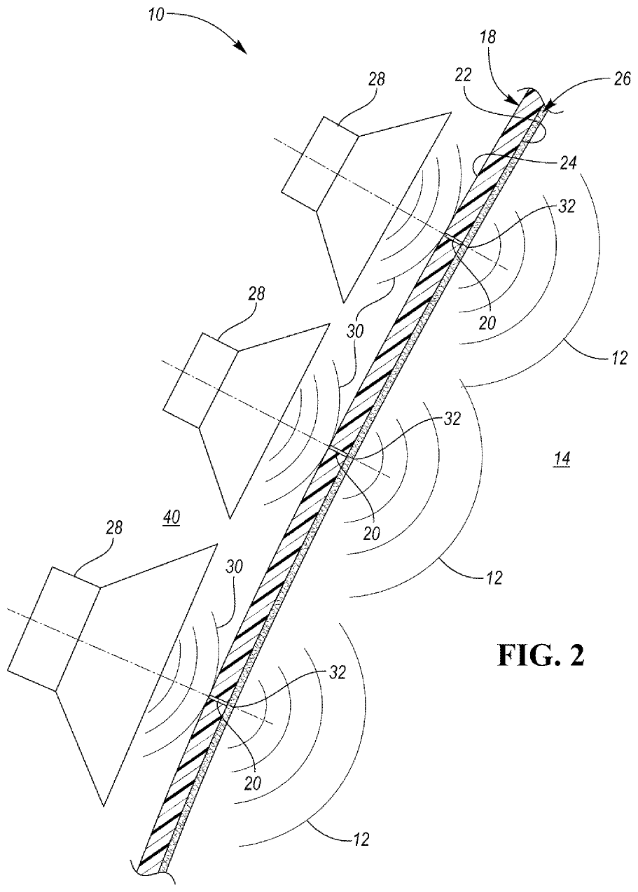

The substrate panel 18 comprise an inner trim panel such as the A-pillar panel of FIG. 1A. However, it is to be understood that the panel assembly 18 may be for other pillars or panels within the passenger compartment 14.

The substrate panel 18 may be concavely formed and the back surface 24 of the substrate panel 18 may define a recess 40 in which the sound sources 28 are disposed.

The sound sources 28 may comprise loudspeakers.

The substrate panel 18 may be configured to be attached to a pillar (not shown) of the support structure.

The array of holes 20 may be microperforations drilled by a laser 42 of FIG. 3 into the substrate panel 18.

The substrate panel 18 may be microperforated with the array of sub-wavelength holes 20.

The facing material may be leather.

At least one embodiment of the present invention takes advantage of the scientific fact that the transmission of sound amplitude in air through walls perforated with subwavelength holes produces intensity enhancements therein. This acoustic transmission is achieved with thin tensioned circular membranes, making the mass of the air in the holes effectively vanish. Imaging the pressure field confirms incident-angle independent transmission, thus realizing a bona fide invisible wall.

This scientific fact is described in the paper entitled, “Giant Acoustic Concentration by Extraordinary Transmission in Zero-Mass Metamaterials,” Phys. Rev. Lett. 110, 244302 (2013).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A low-profile panel assembly configured to provide sound having at least one acoustic wavelength within a passenger compartment of a vehicle having a support structure, the assembly comprising:
a substrate panel perforated with at least one sub-wavelength hole which extends between front and back surfaces of the panel, the panel being configured to be attached to the support structure;
a continuous membrane of facing material overlying and in contact with the panel, the membrane being tightly stretched over and covering the at least one hole at the front surface of the panel; and
an electroacoustic sound source configured to radiate acoustic waves against the back surface of the panel, wherein the radiated acoustic waves travel through the at least one membrane-covered hole to vibrate at least one portion of the membrane which tightly covers the at least one hole and wherein the at least one vibrating portion of the membrane radiates acoustic waves into the passenger compartment of the vehicle.

2. The assembly as claimed in claim 1, wherein the substrate panel is a plastic molded panel.

3. The assembly as claimed in claim 2, wherein the plastic molded panel is injection molded.

4. The assembly as claimed in claim 1, wherein the substrate panel comprises an automotive vehicle trim panel.

5. The assembly as claimed in claim 1, wherein the substrate panel is concavely formed and the back surface of the substrate panel defines a recess in which the sound source is disposed.

6. The assembly as claimed in claim 5, wherein the sound source comprises a loudspeaker.

7. The assembly as claimed in claim 1, wherein the substrate panel is configured to be attached to a pillar of the support structure.

8. The assembly as claimed in claim 1, wherein the at least one hole is a microperforation which is laser-drilled in the substrate panel.

9. The assembly as claimed in claim 1, wherein the substrate panel is microperforated with a plurality of sub-wavelength holes.

10. The assembly as claimed in claim 1, wherein the facing material includes leather.

11. A low-profile panel assembly configured to provide sound having at least one acoustic wavelength within a passenger compartment of a vehicle having a support structure, the assembly comprising:
a substrate panel perforated with an array of sub-wavelength holes which extend between front and back surfaces of the panel, the panel being configured to be attached to the support structure;
a continuous membrane of facing material overlying and in contact with the panel, the membrane being tightly stretched over and covering the array of holes at the front surface of the panel; and
a plurality of electroacoustic sound sources configured to radiate acoustic waves against the back surface of the panel wherein the radiated acoustic waves travel through the array of membrane-covered holes to vibrate portions of the membrane which tightly cover the array of holes and wherein the vibrating portions of the membrane radiate acoustic waves into the passenger compartment of the vehicle.

12. The assembly as claimed in claim 11, wherein the substrate panel is a plastic molded panel.

13. The assembly as claimed in claim 12, wherein the plastic molded panel is injection molded.

14. The assembly as claimed in claim 11, wherein the substrate panel comprises an automotive vehicle trim panel.

15. The assembly as claimed in claim 11, wherein the substrate panel is concavely-formed and the back surface of the substrate panel defines a recess in which the sound sources are disposed.

16. The assembly as claimed in claim 15, wherein the sound sources comprise loudspeakers.

17. The assembly as claimed in claim 11, wherein the substrate panel is configured to be attached to a pillar of the support structure.

18. The assembly as claimed in claim 11, wherein the array of holes are microperforations which are laser-drilled in the substrate panel.

19. The assembly as claimed in claim 11, wherein the substrate panel is microperforated with the array of sub-wavelength holes.

20. The assembly as claimed in claim 11, wherein the facing material includes leather.
